(19) United States
(12) Patent Application Publication
(10) Pub. No.: US 2019/0249489 A1
(43) Pub. Date: Aug. 15, 2019

(54) Security Screen Door for Sliding Doors

(71) Applicant: Charles Young, San Tan, AZ (US)

(72) Inventor: Charles Young, San Tan, AZ (US)

(21) Appl. No.: 16/225,149

(22) Filed: Dec. 19, 2018

Related U.S. Application Data
(60) Provisional application No. 62/630,306, filed on Feb. 14, 2018.

(51) Int. Cl. E06B 9/52; E06B 9/04

(52) U.S. Cl. CPC E06B 9/52; E06B 9/04

(57) ABSTRACT

The embodied invention is an outer security door design that retrofits an existing sliding door. The door design comprises an outer frame which secures into the framework of an existing sliding door. An inner rotating security screen door then fits into the outer frame. The outer frame includes important support underneath the lower frame center point, as the weight of the rotating screen door provides higher stress at that location. The outer frame allows the screen door to be latched in the open or closed position.

### CROSS REFERENCE TO RELATED APPLICATIONS

This application claims the benefit of U.S. provisional application No. 62/630,306 file on Feb. 14, 2018. The provisional application is incorporated by reference.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

This invention is directed toward outer security doors that provide additional security to a sliding door.

### (2) Description of Related Art

Sliding door installations are common on many home designs. The ability to open a door that is very wide and have easy access to a backyard, porch, or deck is very common. There are, however, some disadvantages with the simplified sliding screen that is a typical feature.

A typical sliding screen that is attached to a sliding door is not designed for security. The screen door is better characterized as a bug screen, as it uses a fiber netting or a light metal screen. The frame for the screen door is not designed for security, is usually very light, and is not lockable with a key.

Screen doors are known to be used in front doors, but the installation of a common front-screen door is difficult to retrofit to a sliding door.

What is needed in the art is a screen door that provides enhanced security, a bug screen, is lockable with a key, and an easy and convenient retrofit.

### BRIEF SUMMARY OF THE INVENTION

The embodied invention is an outer security door design that retrofits an existing sliding door opening. The embodied door design comprises an outer frame which is secured into the framework of an existing sliding door. An inner rotating security screen door then fits into the outer frame. The outer frame includes an adjustable center support underneath the lower frame center point, which supports the weight of the rotating screen door and lowers frame stress. The embodied design allows the screen door to be latched in the open or closed position.

### BRIEF DESCRIPTION OF THE SEVERAL VIEWS OF THE DRAWING(S)

FIG. 1 shows the outer mounting frame and the rotating security door of the embodied invention.

FIG. 2 shows the security door rotated to the open position.

FIGS. 3A-3C show important details of the lower door support and other items.

FIG. 4 illustrates the assembly of the outer door frame.

### DETAILED DESCRIPTION OF THE INVENTION

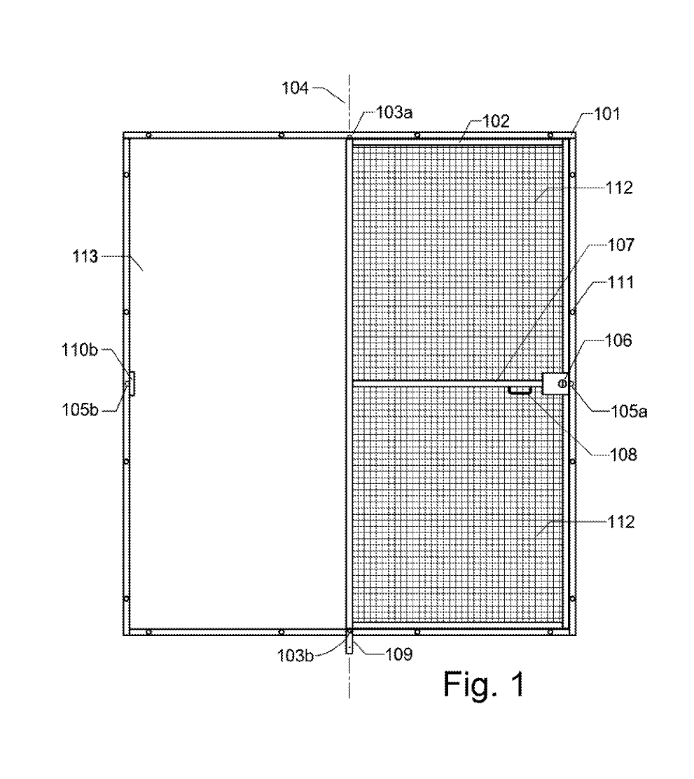

FIG. 1 illustrates the general features of the embodied invention. An outer door frame 101 supports an inner security door frame 102, and fits into an existing sliding door window opening. The design is adaptable in width and height to fit most sliding door openings by suitable adjustments in width and height to the parts of the outer door frame. The inner and outer door frames are preferably made from a metal, such as one inch steel tubing, and are welded or fitted together. The outer frame is secured to an existing opening by use of bolts through hole openings 111 which are screwed into the existing sliding door window opening.

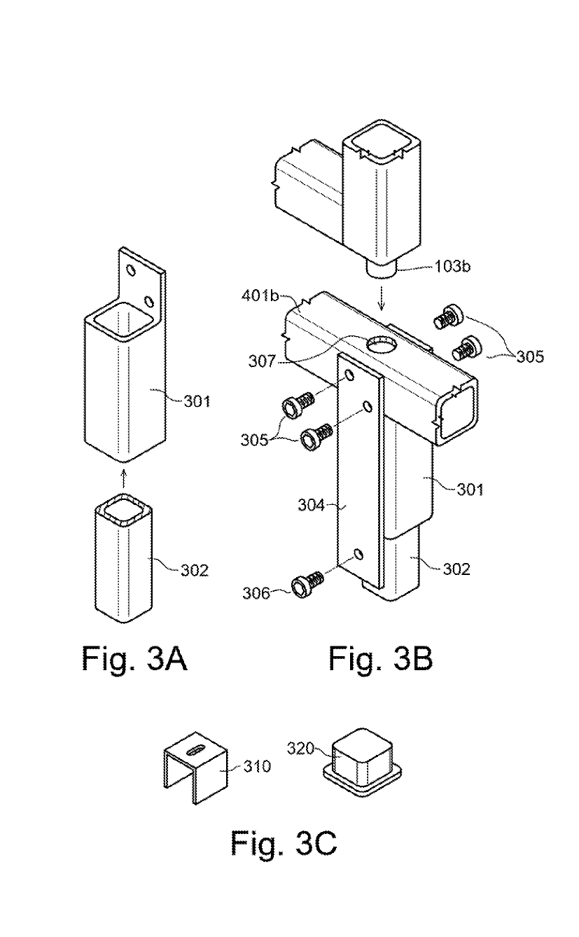

The inner security door rotates about a vertical axis 104 by use of an upper and lower pin 103a,b that fits into a hole that is drilled into the outer frame. A center support 109 provides enhanced support for the inner security screen door frame 102 by use of a metal tubing. See FIGS. 3A-3B for details of the center support 109.

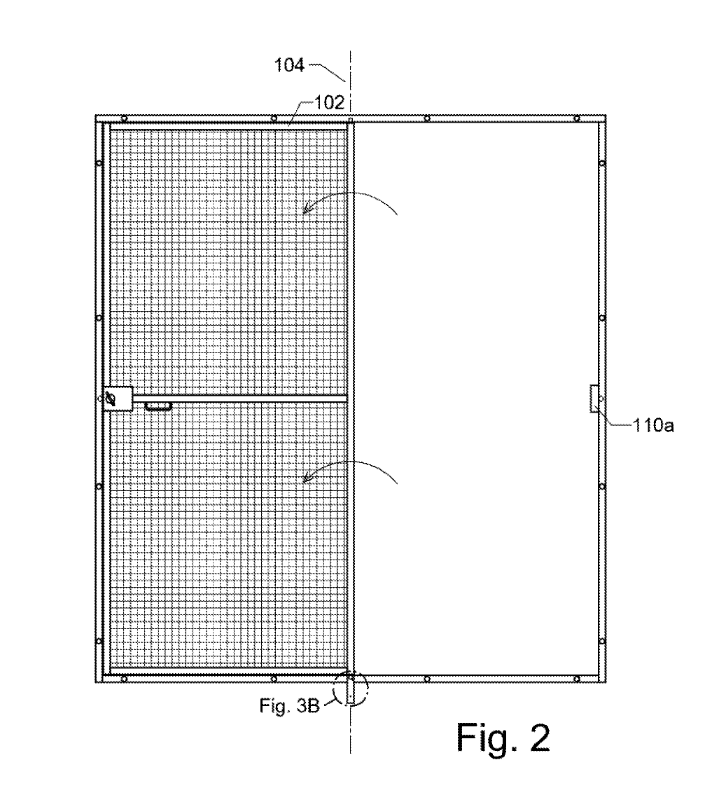

FIG. 1 shows the security door in the closed position. The door is prevented from opening by a right side deadbolt-hole 105a and a door deadbolt. A door stop plate 110a (FIG. 2) is welded to the outer door frame to improve security by preventing the door from being forced inwardly. Also, when closing the door, the door stop plate 110a secures the door position so that the door deadbolt will correctly slide into the deadbolt-hole. A horizontal tubing 107 substantially midway between the upper and lower tubing frame adds door strength. A handle 108 provides a gripping surface for opening and closing the door. An additional handle is optionally on the other side of the door.

In the closed position, the security door deadbolt is operated by a key in the keyhole 106. In the open position, the security door deadbolt slides into a left side deadbolt-hole 105b. Similarly, when at the open position, the door is prevented from rotating too far by a left side door stop plate 110b.

The security door incorporates a metal security screen 112 made from a mesh metal, which provides enhanced strength, and resistance to forced openings. The opening 113 on the other side of the metal frame is preferably left open. In an alternate embodiment, glass is used to fill the opening 113. The glass will need to be positioned behind the door stop plate 110b and suitably accommodate a door handle.

FIG. 2 shows the security door rotated to the open position. In this view, the door stop 110a for the security door in the closed position is visible. Rugged door stops 110a,b are an important feature of the embodied invention as it provides enhanced resistance to damage if the heavier security door slams open or closed. Preferably, the door stops are made from a ½″ metal bar stock and welded to the back outer door frame, so that the inner security door is flush with the outer support frame when the door is either closed or open.

For the sake of defining positions, in FIG. 1, the door is in the closed position. In FIG. 2, the door is in the open position. The viewer looks at the door when standing outside a house. However, this is not a strict requirement and is only defined for convenience and clarity of explanation. Open generally means when the door is positioned to allow someone to pass through the door opening.

It should be readily appreciated by those in the art, that the security door as seen in FIGS. 1 and 2 is designed for a right-hand orientation. The orientation of the door could equally be a left-hand orientation by relatively minor changes to the inner security door, such as flipping the door lock and relocating the door handle. The ability to easily switch the security door between left-hand and right-hand orientation is an important feature for retrofitting simplicity.

FIGS. 3A-3B shows details of the center lower support 109 as mentioned in FIG. 1. A vertical support tubing 301 is machined from 1″ metal tubing stock, with attachment holes. An adjustment section 302 slides into the vertical support member as illustrated, so that the overall length of the center lower support is adjustable. FIG. 3B illustrates the assembly of the vertical support member 301, and the adjustable section 302 onto the lower outer frame tubing 401b using securing screws 305 through a support plate 304. The adjustment section 302 is positioned during installation and then secured in position by a position screw 306. Preferably, all screws shown in FIG. 3B are of the self taping type.

The lower pin 103b is inserted into the hole 307 on the lower door tubing 401b. An optional insert is used to lower wear between the hole and the lower door tubing. The upper pin is similarly installed on the upper outer frame tubing.

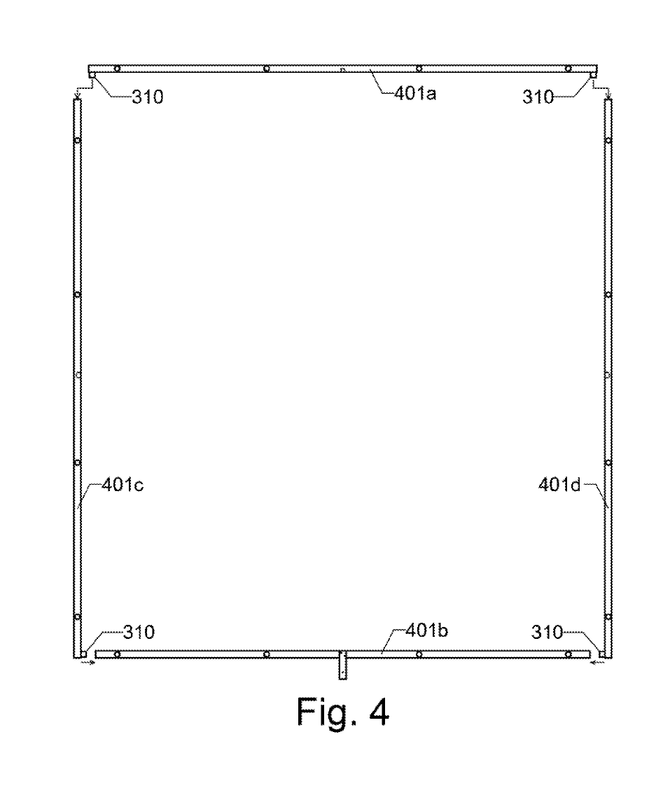

In FIG. 3C an alignment bracket 310 is used to help align the inner/outer frame and further illustrated in FIG. 4. A plastic end cap 320 is preferably used in the assembly of the inner and outer door frames to minimize sharp edges.

FIG. 4 illustrates the assembly of the outer frame. The outer frame comprises an upper horizontal support 401a, a lower horizontal support 401b, a left side vertical support 401c and a right side vertical support 401d. Preferably the four supports are made from metal tubing. An alignment bracket 310 is used to assemble the supports as illustrated. The alignment bracket fits snugly into the supports. The alignment bracket is screwed or welded onto the supports. The brackets aid in keeping the frame square and allows for some minor flexibility in length during installation.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. A security door assembly for a sliding door frame comprising:
A. a rectangular shaped outer frame with attaching holes,
B. said outer frame further comprises:
1. a left vertical member and a right vertical member, and an upper member and a lower member,
2. said outer frame is made from metal tubing,
3. a lower center adjustable support,
4. a deadbolt recess on both vertical members,
5. a central lower pin recess in side upper member and a central upper pin recess in said lower member,
6. wherein both said lower pin recesses and said upper pin recess are aligned vertically, and
7. a door rotating axis coaxial with said central lower pin recess and said central upper pin recess,
C. a rectangular shaped security door,
D. said security door further comprises:
1. a left vertical tubing and a right vertical tubing, an upper horizontal tubing, and a lower horizontal tubing,
2. a lower pin that fits into said lower pin recess and an upper pin that fits into said upper pin recess,
3. said lower pin and said upper pin are coaxial with said door rotating axis,
4. said lower pin is located on the proximal end of said lower horizontal tubing,
5. said upper pin is located on the proximal end of said upper horizontal tubing,
6. a middle horizontal tubing centrally located between said upper horizontal tubing and said lower horizontal tubing, said middle horizontal tubing with a distal end and proximal end with respect to said rotating axis,
7. a deadbolt positioned on said distal end of said middle horizontal tubing to engage with:
i. said deadbolt recess located on said right vertical member when in the closed position, and
ii. said deadbolt recess located on said left vertical member when in the open position, and
8. a metal security screen positioned inside said rectangular shape of said security door,
E. an adjustable support centrally positioned under said lower member,
F. said adjustable support further comprising:
1. a vertical adjustment tubing,
2. a vertical support tubing,
3. said vertical adjustment tubing slides inside said vertical support tubing,
4. a support plate, and
5. screws to secure said vertical adjustment tubing and said support plate to said vertical support tubing.
